(19) United States
(12) Patent Application Publication
(10) Pub. No.: US 2025/0225956 A1
(43) Pub. Date: Jul. 10, 2025

(54) ELECTRONIC DEVICE AND METHOD FOR CONTROLLING MEMORY IN DISPLAY

(71) Applicant: Samsung Electronics Co., Ltd., Suwon-si (KR)

(72) Inventors: Jaesung LEE, Suwon-si (KR); Kyounghwan KWON, Suwon-si (KR); Jongkon BAE, Suwon-si (KR); Donghwy KIM, Suwon-si (KR); Byungduk YANG, Suwon-si (KR)

(21) Appl. No.: 19/089,976

(22) Filed: Mar. 25, 2025

Related U.S. Application Data
(63) Continuation of application No. PCT/KR2023/014937, filed on Sep. 26, 2023.

(30) Foreign Application Priority Data
Sep. 30, 2022 (KR) 10-2022-0125365
Jan. 4, 2023 (KR) 10-2023-0001471
Jan. 11, 2023 (KR) 10-2023-0004343
Feb. 2, 2023 (KR) 10-2023-0014506
Mar. 3, 2023 (KR) 10-2023-0028693
Sep. 25, 2023 (WO) PCT/KR2023/014711

(51) Int. Cl. G09G 5/39; G09G 3/20

(52) U.S. Cl. CPC G09G 5/39; G09G 3/20

(57) ABSTRACT

An electronic device may include: a display driving circuit including a graphic random access memory (GRAM); and a display panel, wherein the display driving circuit can be configured to: display an image on the display panel on the basis of scanning the image in the GRAM having a first active state for acquiring power within a first range; and change, in response to the scanning, the state of the GRAM from the first active state to a second active state for acquiring power within a second range that is lower than the power within the first range, in order to maintain the image in the GRAM. The refresh rate for the image in the GRAM can be lower than a standard refresh rate.

### CROSS-REFERENCE TO RELATED APPLICATIONS

This application is a continuation application of International Application No. PCT/KR2023/014937 designating the United States, filed on Sep. 26, 2023, in the Korean Intellectual Property Receiving Office and claiming priority to Korean Patent Application No. 10-2022-0125365, filed on Sep. 30, 2022, Korean Patent Application No. 10-2023-0001471, filed on Jan. 4, 2023, Korean Patent Application No. 10-2023-0004343, filed on Jan. 11, 2023, Korean Patent Application No. 10-2023-0014506, filed on Feb. 2, 2023, Korean Patent Application No. 10-2023-0028693, filed on Mar. 3, 2023, and PCT/KR2023/014711 filed Sep. 25, 2023, the disclosures of which are all hereby incorporated by reference herein in their entireties.

### BACKGROUND

### Technical Field

Certain example embodiments may relate to an electronic device and/or a method for controlling memory in a display.

### Description of Related Art

An electronic device may include a display panel. For example, the electronic device may include a display driver circuitry operably coupled to the display panel. For example, the display driver circuitry may display an image obtained from a processor of the electronic device on the display panel.

The above-described information may be provided as a related art for the purpose of helping to understand the present disclosure. No claim or determination is raised as to whether any of the above-described information may be applied as a prior art related to the present disclosure.

### SUMMARY

An electronic device may comprise display driver circuitry including a graphic random access memory (GRAM). The electronic device may comprise a display panel. The display driver circuitry may be configured to, based on scanning an image in the GRAM having a first activation state obtaining power in a first range, display the image on the display panel. The display driver circuitry may be configured to, in response to the scanning, change a state of the GRAM from the first activation state to a second activation state obtaining power in a second range for maintaining the image in the GRAM, the power in the second range lower than the power in the first range. A refresh rate for the image in the GRAM may be lower than a reference refresh rate.

A method may be executed in an electronic device including display driver circuitry and a display panel. The method may comprise, based on scanning an image in the GRAM having a first activation state obtaining power in a first range, displaying, by the display driver circuitry, the image on the display panel. The method may comprise, in response to the scanning, changing, by the display driver circuitry, a state of the GRAM from the first activation state to a second activation state obtaining power in a second range for maintaining the image in the GRAM, the power in the second range lower than the power in the first. A refresh rate for the image in the GRAM may be lower than a reference refresh rate.

### DESCRIPTION OF THE DRAWINGS

FIG. 1 is a simplified block diagram of an exemplary electronic device.

FIG. 2 illustrates an example of states of a graphic random access memory (GRAM) in display driver circuitry.

FIG. 3 illustrates an exemplary method of changing a state of GRAM from a first activation state to a second activation state.

FIG. 4 illustrates an exemplary method of changing a state of GRAM from a second activation state to a first activation state.

FIG. 5 illustrates an exemplary method of changing a state of GRAM from a second activation state to a deactivation state.

FIG. 6 illustrates an exemplary method of changing a state of GRAM from a second activation state to a first activation state after a control command indicating to cease activating GRAM is obtained.

FIG. 7 illustrates an exemplary method of changing a state of GRAM from a second activation state to a deactivation state after a control command indicating to cease activating GRAM is obtained.

FIG. 8 is a block diagram of an electronic device in a network environment according to various example embodiments.

FIG. 9 is a block diagram of a display module according to various example embodiments.

### DETAILED DESCRIPTION

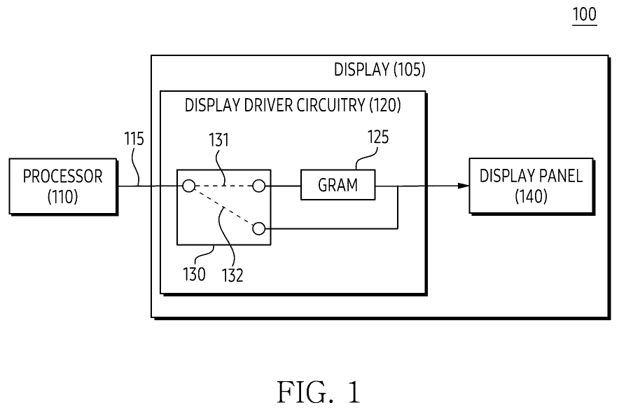

FIG. 1 is a simplified block diagram of an exemplary electronic device.

Referring to FIG. 1, an electronic device 100 may include a display 105 and a processor 110.

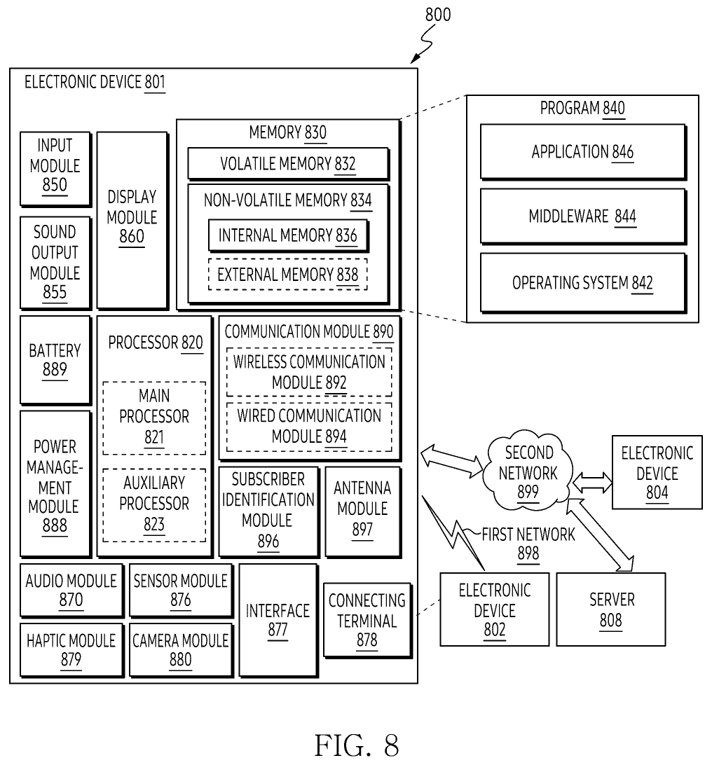

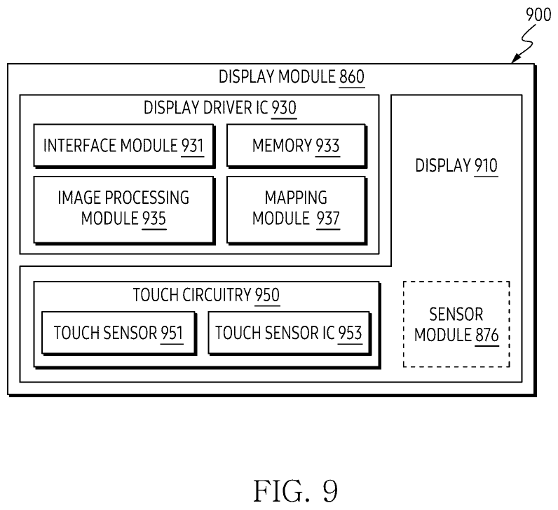

The display 105 may include display driver circuitry 120 and a display panel 140. For example, the display 105 may include at least a portion of a display module 860 of FIGS. 8 and 9.

For example, the display driver circuitry 120 may include at least a portion of a DDI 930 of FIG. 9. For example, the display driver circuitry 120 may include a graphic random access memory (GRAM) 125, which is a volatile memory. For example, the GRAM 125 may include at least a portion of memory 833 of FIG. 8. For example, the display driver circuitry 120 may further include a switch 130. For example, the GRAM 125 may be connectable to the processor 110 through the switch 130. For example, the GRAM 125 may be connected, directly or indirectly, to the processor 110 through the switch 130 in a first state 131. For example, the GRAM 125 may be disconnected from the processor 110 through the switch 130 in a second state 132.

Although FIG. 1 illustrates an example in which the switch 130 is included in the display driver circuitry 120, the switch 130 may be located outside the display driver circuitry 120, unlike the illustration in FIG. 1. However, it is not limited thereto.

For example, the display panel 140 may include at least a portion of the display 910 of FIG. 9. For example, the display panel 140 may include a low temperature poly-crystalline oxide (LTPO) thin film transistor (TFT) or a low temperature poly-silicon (LTPS) TFT. However, it is not limited thereto. For example, the display panel 140 may be operably coupled to the display driver circuitry 120.

The processor 110 may include at least a portion of a processor 820 of FIG. 8. For example, the processor 110 may be connected to the display driver circuitry 120 through an interface 115. For example, the interface 115 may be used to transmit an image from the processor 110 to the display driver circuitry 120. For example, the processor 110 may be operably coupled to the display driver circuitry 120 through the interface 115. As a non-limiting example, the interface 115 may include a mobile industry processor interface (MIPI).

For example, the processor 110 and the display driver circuitry 120 may be configured to execute operations to be illustrated below.

For example, the processor 110 may obtain or render an image to be displayed on the display panel 140. For example, the processor 110 may transmit the image to the display driver circuitry 120 through the interface 115.

For example, the display driver circuitry 120 may receive the image from the processor 110 through the interface 115. For example, the display driver circuitry 120 may display the image on display panel 140.

For example, the display driver circuitry 120 may store the image in the GRAM 125 or bypass storing the image in the GRAM 125.

For example, the display driver circuitry 120 may bypass storing the image in the GRAM 125 and display the image received from the processor 110 through the interface 115 on the display panel 140.

For example, the display driver circuitry 120 may display the image received from the processor 110 and store the image in the GRAM 125. For example, the display driver circuitry 120 may display the image on the display panel 140, based on scanning the image stored in the GRAM 125. As a non-limiting example, the scanning of the image may be repeatedly executed to maintain the image on the display panel 140. For example, the display driver circuitry 120 may maintain the image on the display panel 140 by executing multiple displaying of the image in accordance with the repeated scanning. For example, the multiple displaying of the image in accordance with the repeated scanning may be executed to reduce power consumed by repeatedly transmitting the image from the processor 110 to the display driver circuitry 120 to maintain the image on the display panel 140. “Based on” as used herein covers based at least on.

For example, the display driver circuitry 120 may execute the multiple displaying of the image, in order to maintain the image on the display panel 140, by executing a first displaying of the image on the display panel 140 in accordance with a first scanning of the image in the GRAM 125, and a second displaying of the image on the display panel 140 in accordance with a second scanning of the image in the GRAM 125. For example, maintaining a state of the GRAM 125 in a state for the second scanning in a time interval between the first scanning and the second scanning may cause power consumption.

For example, the processor 110 may transmit another image to the display driver circuitry 120 at a timing for an image transmission, after the first scanning is executed and before the second scanning is executed. For example, the display driver circuitry 120 may store the other image in the GRAM 125. For example, maintaining a state of the GRAM 125 in a state for storing the other image (corresponding to the state for the second scanning) in a time interval between the first scanning and the storing of the other image may cause power consumption.

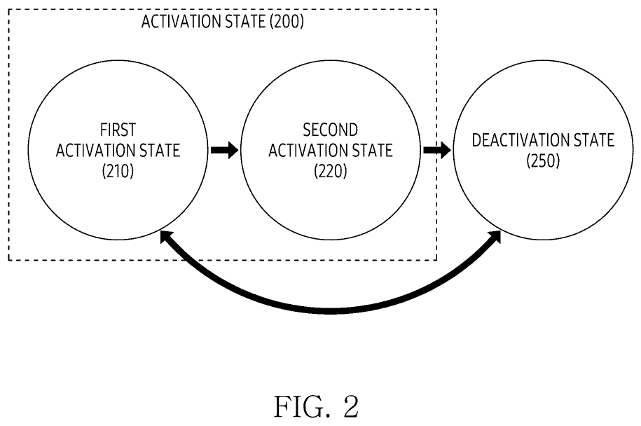

For example, the GRAM 125 may have a state for reducing the consumption of the power. The state may be illustrated through FIG. 2.

FIG. 2 illustrates an example of states of a graphic random access memory (GRAM) in display driver circuitry.

Referring to FIG. 2, the GRAM 125 may have an activation state 200 and a deactivation state 250. The activation state 200 may indicate a state of obtaining power for use of the GRAM 125. The activation state 200 may include a first activation state 210 and a second activation state 220.

For example, the first activation state 210 may indicate a state of executing storing an image (or a new image) in the GRAM 125 (e.g., writing an image in the GRAM 125) and scanning an image in the GRAM 125 (e.g., reading an image written in the GRAM 125). For example, the first activation state 210 may indicate a state in which the GRAM 125 obtains power in a first range. For example, the first activation state 210 may be provided based on a first voltage provided to the GRAM 125.

For example, the second activation state 220 may indicate a state of maintaining an image in the GRAM 125 (or an image written in the GRAM 125). For example, the second activation state 220 may be a state for reducing the consumption of the power. For example, storing an image in the GRAM 125 and scanning an image in the GRAM 125 may be disabled or restricted while the GRAM 125 has the second activation state 220. For example, storing an image in the GRAM 125 and scanning an image in the GRAM 125 may be unavailable while the GRAM 125 has the second activation state 220. For example, storing an image in the GRAM 125 and scanning an image in the GRAM 125 may be executable while the GRAM 125 has the first activation state 210 among the first activation state 210 and the second activation state 220. For example, the second activation state 220 may indicate a state in which the GRAM 125 obtains power within a second range lower than the first range. For example, the second activation state 220 may be provided based on a second voltage provided to the GRAM 125. For example, the second voltage may be lower than the first voltage.

For example, the deactivation state 250 may indicate a state in which storing an image (or new image) in the GRAM 125, scanning an image in the GRAM 125, and maintaining an image in the GRAM 125 are disabled or restricted. For example, the deactivation state 250 may indicate a state in which storing an image (or new image) in the GRAM 125, scanning an image in the GRAM 125, and maintaining an image in the GRAM 125 are unavailable. For example, the deactivation state 250 may indicate a state in which power for use of the GRAM 125 is not obtained. As a non-limiting example, the GRAM 125 having the deactivation state 250 may obtain other power distinct from the power. For example, the GRAM 125 having the deactivation state 250 may obtain the other power, which is power within a third range lower than the second range.

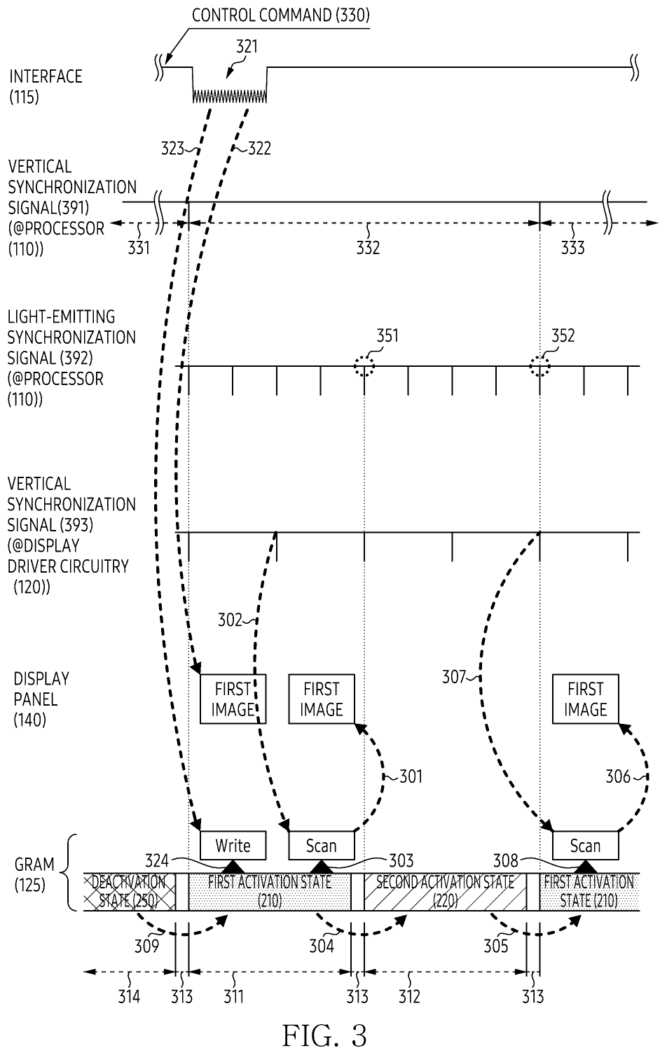

For example, a state of the GRAM 125 may be changed. For example, the display driver circuitry 120 may change the state from the first activation state 210 to the second activation state 220, change the state from the second activation state 220 to the first activation state 210, change the state from the first activation state 210 to the deactivation state 250, change the state from the deactivation state 250 to the first activation state 210, or change the state from the second activation state 220 to the deactivation state 250. The change of the state may be illustrated through FIGS. 3 to 7.

FIG. 3 illustrates an exemplary method of changing a state of GRAM from a first activation state to a second activation state.

Referring to FIG. 3, display driver circuitry 120 may display a first image on a display panel 140 based on scanning the first image in GRAM 125, as indicated by arrow 301. For example, the scanning of the first image may be executed based on a vertical synchronization signal 393 for the display driver circuitry 120, as indicated by arrow 302. For example, the scanning of the first image may be executed while the GRAM 125 has a first activation state 210 obtaining the power within the first range, as indicated by arrow 303.

For example, the display driver circuitry 120 may change, in response to the scanning of the first image, a state of the GRAM 125 from the first activation state 210 to a second activation state 220 obtaining the power within the range, as indicated by arrow 304. For example, the second activation state 220 may be a state for maintaining the first image in the GRAM 125.

As a non-limiting example, the change from the first activation state 210 to the second activation state 220 may be completed before a timing 351 capable of executing an image transmission from the processor 110 to the display driver circuitry 120. For example, the timing 351 may be a timing of a vertical synchronization signal 393 capable of starting displaying an image. For example, the timing 351 may be a timing of a light-emitting synchronization signal 392 for the processor 110. For example, the light-emitting synchronization signal 392 may indicate a timing of a light-emitting signal from the display driver circuitry 120 to the display panel 140. Although not illustrated in FIG. 3, the display driver circuitry 120 may be within a state capable of receiving an image from the processor 110 based on the light-emitting synchronization signal 392 while the GRAM 125 has the second activation state 220. For example, since the GRAM 125 has the second activation state 220, the display driver circuitry 120 may bypass storing the image received from the processor 110 in the GRAM 125 and display the image on the display panel 140. However, it is not limited thereto. For example, the change from the first activation state 210 to the second activation state 220 may be completed after the timing 351.

As a non-limiting example, the display driver circuitry 120 may change the state from the first activation state 210 to the second activation state 220 to have a reference time interval 313 between a time interval 311 in which the GRAM 125 has the first activation state 210 and a time interval 312 in which the GRAM 125 has the second activation state 220. For example, the reference time interval 313 may be scheduled (or defined) between the time interval 311 and the time interval 312 to change the power (or voltage) within the first range to the power (or voltage) within the second range.

For example, the display driver circuitry 120 may change the state from the second activation state 220 to the first activation state 210 for scanning again the first image, as indicated by arrow 305.

As a non-limiting example, the change from the second activation state 220 to the first activation state 210 may be completed before a timing 352 capable of executing an image transmission from the processor 110 to the display driver circuitry 120. For example, the timing 352 may be a timing of a vertical synchronization signal 393 capable of starting displaying an image. For example, the timing 352 may be a timing of a light-emitting synchronization signal 392 for the processor 110.

For example, the display driver circuitry 120 may display the first image on the display panel 140 by scanning again the first image maintained in the GRAM 125 based on the second activation state 220, as indicated by arrow 306. For example, scanning again the first image may be executed based on the vertical synchronization signal 393, as indicated by arrow 307. For example, scanning again the first image may be executed while the GRAM 125 has the first activation state 210, as indicated by arrow 308.

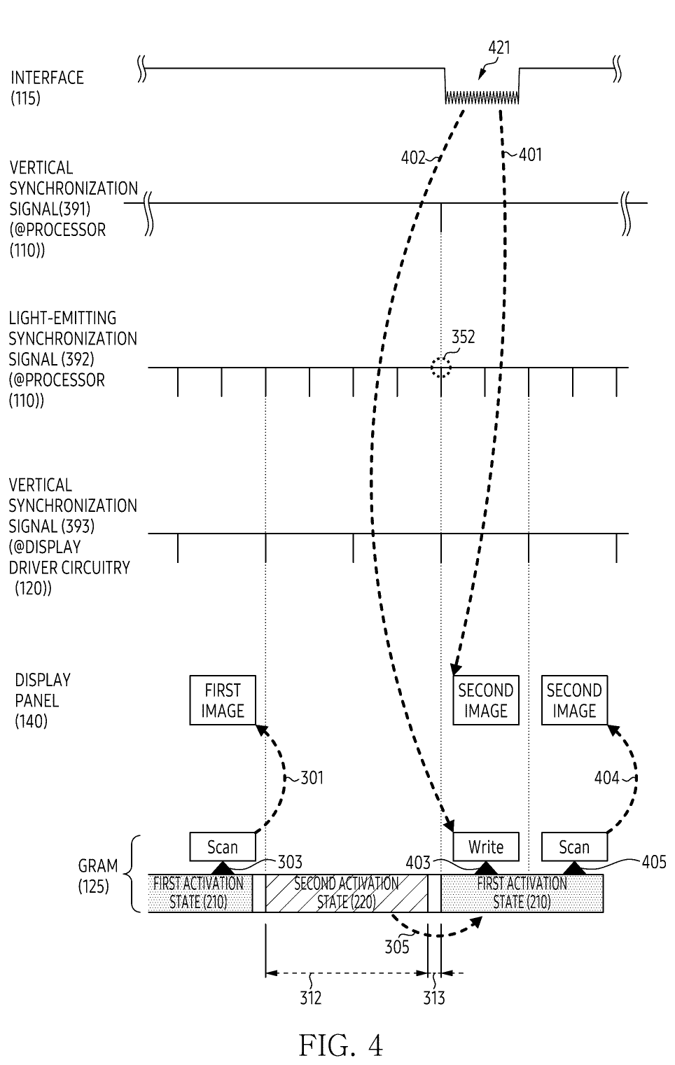

Although FIG. 3 illustrates an example in which the change from the second activation state 220 to the first activation state 210 is executed for scanning again the first image, the change from the second activation state 220 to the first activation state 210 may be executed for storing an image received from the processor 110. Changing from the second activation state 220 to the first activation state 210 executed for storing the image received from the processor 110 may be illustrated through FIG. 4.

FIG. 4 illustrates an exemplary method of changing a state of GRAM from a second activation state to a first activation state.

Referring to FIG. 4, display driver circuitry 120 may receive a second image subsequent to the first image from a processor 110 through an interface 115 as in a state 421. For example, the second image may be received from the processor 110 through the interface 115, based on a timing of a vertical synchronization signal 391 for the processor 110. For example, the timing of the vertical synchronization signal 391 may be identified based on a timing (e.g., timing 352) of a light-emitting synchronization signal 392. For example, the timing of the vertical synchronization signal 391 may correspond to the timing of the light-emitting synchronization signal 392.

For example, the display driver circuitry 120 may display the second image received from the processor 110 on the display panel 140, as indicated by arrow 401. For example, the display driver circuitry 120 may execute a first displaying of the second image on the display panel 140, as indicated by arrow 401.

For example, the display driver circuitry 120 may change the state from a second activation state 220 to a first activation state 210 for storing the second image received from the processor 110 in the GRAM 125, as indicated by arrow 305.

For example, the display driver circuitry 120 may store the second image in the GRAM 125, as indicated by arrow 402. For example, storing the second image in the GRAM 125 may be executed while the GRAM 125 has the first activation state 210, as indicated by arrow 403.

For example, the display driver circuitry 120 may execute a second displaying of the second image on the display panel 140, based on scanning the second image in the GRAM 125, as indicated by arrow 404. For example, the scanning of the second image may be executed while the GRAM 125 has the first activation state 210, as indicated by arrow 405. Although not illustrated in FIG. 4, the display driver circuitry 120 may change the state of the GRAM 125 from the first activation state 210 to the second activation state 220, in response to the scanning of the second image.

Referring back to FIG. 3, the change from the first activation state 210 to the second activation state 220 may be executed based on a control command 330 obtained from the processor 110. As a non-limiting example, the control command 330 may be referred to as still indication. For example, the still indication may include sticky flag indication and/or on-the-fly indication.

For example, the control command 330 may indicate activating the GRAM 125 for displaying on the display panel 140. For example, the control command 330 may indicate changing the state of the GRAM 125 from the deactivation state 250 to the first activation state 210. For example, the processor 110 may provide the control command to the display driver circuitry 120, based on a refresh rate for the first image, which is lower than a reference refresh rate. For example, the refresh rate for the first image may indicate a refresh rate identified or targeted when obtaining or rendering the first image. For example, the refresh rate for the first image may be identical to or different from a refresh rate provided on (or through) the display panel 140 in accordance with displaying the first image. However, it is not limited thereto.

As a non-limiting example, since the control command 330 is provided from the processor 110 to the display driver circuitry 120 based on the refresh rate for the first image lower than the reference refresh rate, the GRAM 125 may have a deactivation state 250 when the refresh rate for the image is higher than or equal to the reference refresh rate.

As a non-limiting example, the control command 330 may be indicated through a synchronization signal. For example, the synchronization signal may be a pulse signal periodically transmitted from the processor 110 to the display driver circuitry 120 for synchronizing an operation of the display driver circuitry 120 associated with displaying on the display panel 140 to an operation of the processor 110 associated with displaying on the display panel 140. A period of the transmission of the pulse signal may correspond to a period of a horizontal synchronization signal (or light-emitting synchronization signal 392) for the processor 110. For example, the processor 110 may change a width of the pulse signal for indicating the control command 330. For example, the display driver circuitry 120 may obtain the control command 330 based on the width of the pulse signal. As a non-limiting example, the pulse signal may be referred to as an external synchronization signal (Esync).

For example, the display driver circuitry 120 may change, in response to the control command 330, the state of the GRAM 125 from the deactivation state 250 to the first activation state 210, as indicated by arrow 309. As a non-limiting example, the display driver circuitry 120 may change the state from the deactivation state 250 to the first activation state 210 to have a reference time interval 313 between a time interval 314 in which the GRAM 125 has the deactivation state 250 and a time interval 311 in which the GRAM 125 has the first activation state 210. For example, the reference time interval 313 may be scheduled (or defined) between the time interval 314 and the time interval 311 to provide the GRAM 125 with power within the first range.

For example, the display driver circuitry 120 may receive the first image from the processor 110 through the interface 115, as in a state 321, after the state is changed from the deactivation state 250 to the first activation state 210. For example, the display driver circuitry 120 may execute a first displaying of the first image, as indicated by arrow 322. For example, the display driver circuitry 120 may store the first image received from the processor 110 in the GRAM 125, as indicated by arrow 323. For example, storing the first image in the GRAM 125 may be executed while the GRAM 125 has the first activation state 210, as indicated by arrow 324.

For example, the display driver circuitry 120 may display the first image on the display panel 140 by executing a second displaying of the first image in accordance with scanning the first image in the GRAM 125, as indicated by arrow 301.

For example, a time interval in which the control command 330 is obtained may be different from a time interval in which the reception of the first image from the processor 110, the first displaying of the first image, the storing of the first image, and the second displaying of the first image in accordance with the scanning of the first image are executed. For example, the display driver circuitry 120 may obtain a control command 330 from the processor 110 within a first time interval 331 being before a second time interval 332. For example, the display driver circuitry 120 may execute, within a portion of the second time interval 332, the reception of the first image from the processor 110, the first displaying of the first image, the storing of the first image, and the second displaying of the first image in accordance with the scanning of the first image. For example, the display driver circuitry 120 may change the state of the GRAM 125 from the first activation state 210 to the second activation state 220 within another portion of the second time interval 332. For example, the state of GRAM 125 may be changed from the second activation state 220 to the first activation state 210 before a third time interval 333 being after the second time interval 332.

FIG. 3 illustrates an example in which each of a start timing of the first time interval 331, a start timing of the second time interval 332, and a start timing of the third time interval 333 corresponds to a start timing of the vertical synchronization signal 391, but this is for convenience of explanation. Each of the start timing of the first time interval 331, the start timing of the second time interval 332, and the start timing of the third time interval 333 may correspond to a timing capable of executing an image transmission from the processor 110 to the display driver circuitry 120. For example, each of the start timing of the first time interval 331, the start timing of the second time interval 332, and the start timing of the third time interval 333 may correspond to a start timing of the light-emitting synchronization signal 392.

For example, the control command 330 may be a first control command or a second control command.

The first control command may indicate storing at least one image received from the processor 110 in the GRAM 125, before a third control command indicating bypassing storing the image received from the processor 110 in the GRAM 125 is provided from the processor 110 to the display driver circuitry 120. The change in the state of the GRAM 125 in accordance with the first control command may be illustrated through FIG. 4.

Referring to FIG. 4, the display driver circuitry 120 may change the state of the GRAM 125 from the second activation state 220 to the first activation state 210 before a timing (e.g., timing 352) capable of starting an image transmission from the processor 110 to the display driver circuitry 120, based on the first control command, as indicated by arrow 305. For example, the display driver circuitry 120 may store, in the GRAM 125 having the first activation state 210, the second image received from the processor 110 based on the timing, as indicated by arrow 402. For example, the display driver circuitry 120 may display, on the display panel 140, the second image received from the processor 110 based on the timing, as indicated by arrow 401. For example, the displaying of the second image may be the first displaying of the second image exemplified above. For example, the display driver circuitry 120 may display again the second image on the display panel 140 by scanning the second image in the GRAM 125 having the first activation state 210. For example, displaying again the second image may be the second displaying of the second image exemplified above.

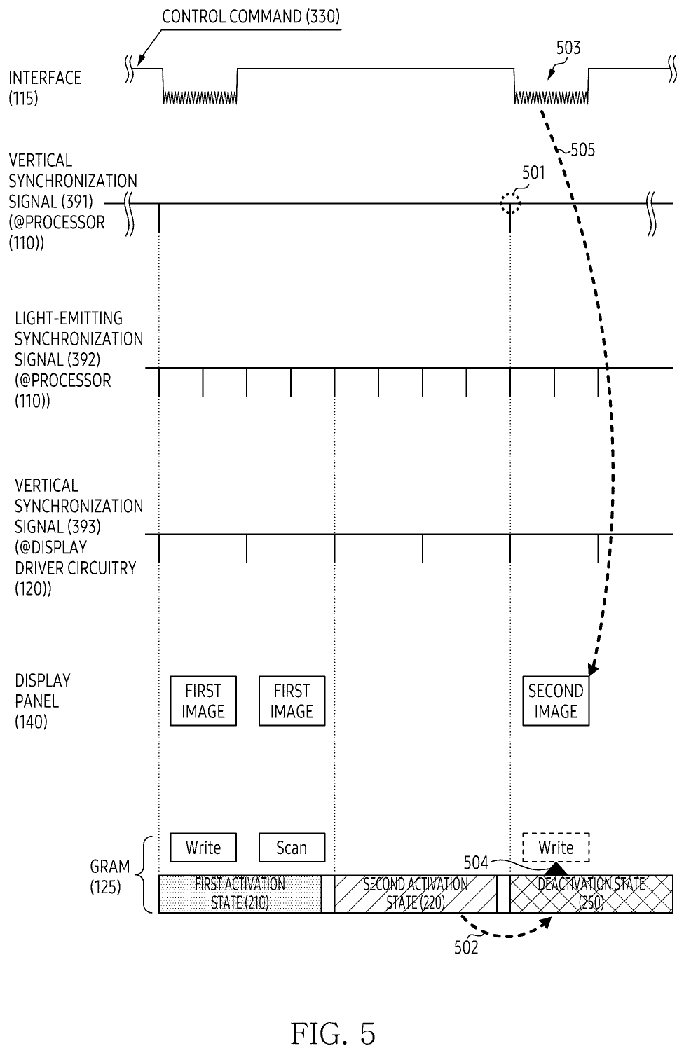

Referring back to FIG. 3, unlike the first control command, the second control command may indicate storing only an image received after the second control command is provided from the processor 110 to the display driver circuitry 120 in the GRAM 125. The change in the state of the GRAM 125 in accordance with the second control command may be illustrated through FIG. 5.

FIG. 5 illustrates an exemplary method of changing a state of GRAM from a second activation state to a deactivation state.

Referring to FIG. 5, the display driver circuitry 120 may execute the operations exemplified through the description of FIG. 3 based on a control command 330 which is the second control command. For example, the display driver circuitry 120 may store the first image in the GRAM 125 having the first activation state 210 and display the first image on the display panel 140 by scanning the first image in the GRAM 125 having the first activation state 210. For example, the displaying of the first image may be the second displaying of the first image exemplified above. For example, the display driver circuitry 120 may change the first activation state 210 to the second activation state 220, in response to the scanning of the first image.

For example, the display driver circuitry 120 may change the state of the GRAM 125 from the second activation state 220 to the deactivation state 250, before a time 501 capable of starting an image transmission from the processor 110 to the display driver circuitry 120, based on a control command 330 which is the second control command, as indicated by arrow 502. For example, the display driver circuitry 120 may receive the second image subsequent to the first image from the processor 110 through the interface 115, as in a state 503. For example, the display driver circuitry 120 may bypass storing the second image in the GRAM 125, as indicated by arrow 504, by changing the state of the GRAM 125 to the deactivation state 250 in accordance with a control command 330 which is the second control command, based on the second image or a timing 501 capable of receiving the second image. For example, the display driver circuitry 120 may display, on display panel 140, the second image received from the processor 110 through the interface 115, as indicated by arrow 505.

FIG. 5 illustrates an example in which a change from the second activation state 220 to the deactivation state 250 is completed before the timing 501 or at the timing 501, but the change from the second activation state 220 to the deactivation state 250 may be completed after the timing 501 has elapsed. For example, since the second activation state 220 is a state restricted from storing the second image and a switch 130 is within a second state 132 based on the timing 501, the display driver circuitry 120 may bypass storing the second image in the GRAM 125 and display the second image on the display panel 140, within at least a portion of a time interval at which the GRAM 125 has the second activation state 220. However, it is not limited thereto.

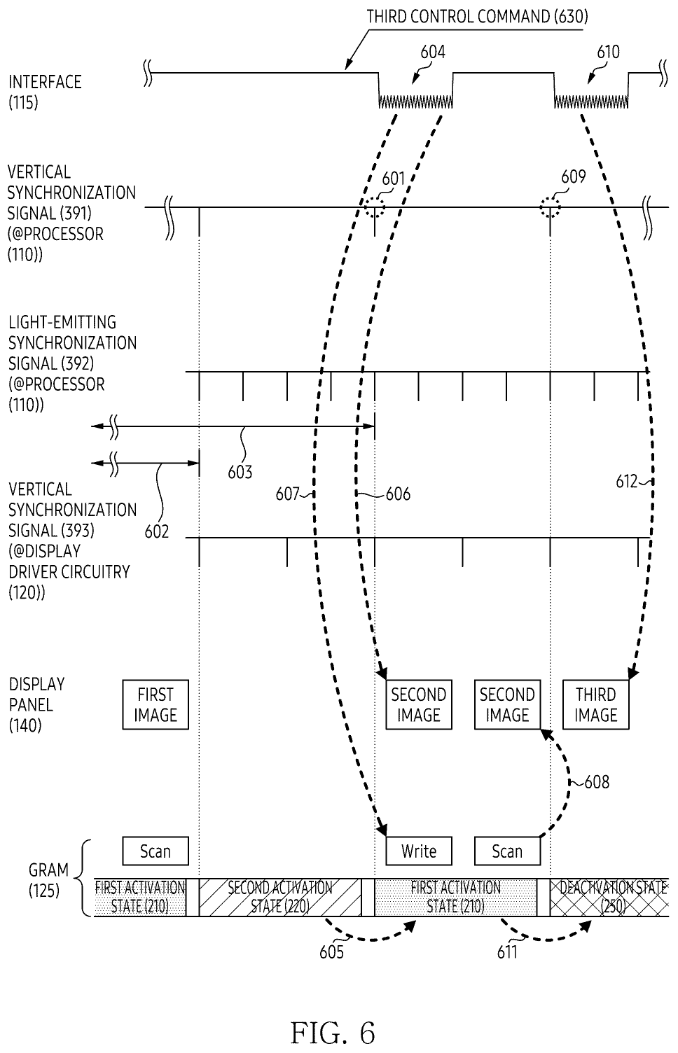

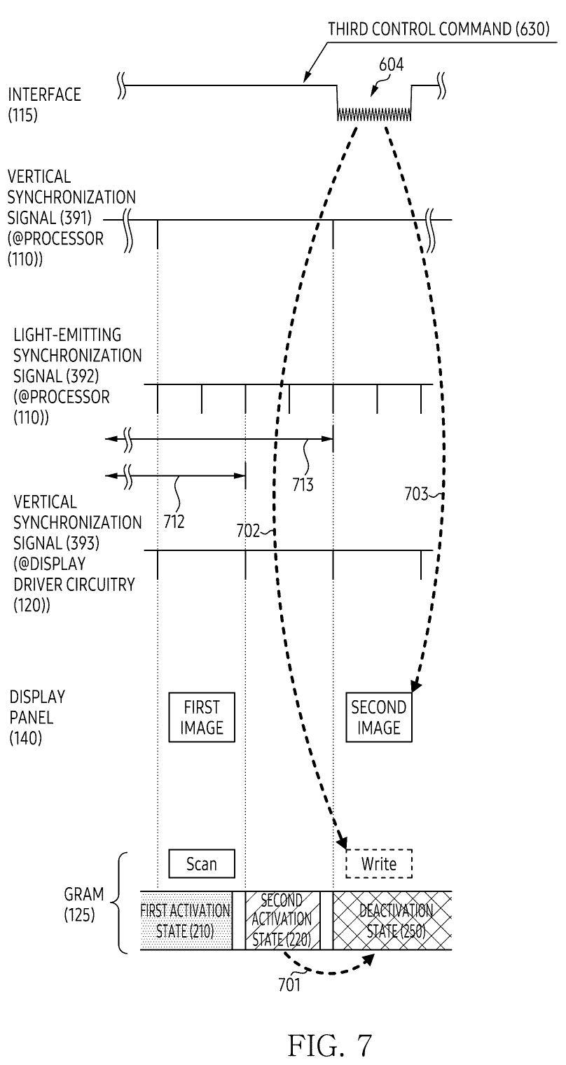

Referring back to FIG. 3, after the third control command is obtained from the processor 110, the display driver circuitry 120 may change the state of the GRAM 125 from the second activation state 220 to the first activation state 210 or change the state of the GRAM 125 from the second activation state 220 to the deactivation state 250. For example, the display driver circuitry 120 may adaptively execute an operation after the third control command is obtained in accordance with a time when an image displayed on the display panel 140 is maintained before the third control command is obtained. The adaptive execution may be illustrated through FIGS. 6 and 7.

FIG. 6 illustrates an exemplary method of changing a state of GRAM from a second activation state to a first activation state after a control command indicating to cease activating GRAM is obtained.

Referring to FIG. 6, display driver circuitry 120 may obtain a control command 630 from a processor 110, before a timing 601 of a vertical synchronization signal 391 (or timing 601 of a light-emitting synchronization signal 392) (or timing 601 of a vertical synchronization signal 393). For example, the third control command 630 may indicate to cease activating the GRAM 125. For example, the display driver circuitry 120 may identify a time length when displaying of the first image on the display panel 140 has been maintained, based on the control command 630. For example, the time length may include at least one time interval in which the first image was ceased on the display panel 140. For example, in case that multiple displays of the first image are executed, the time length may include time between the multiple displays. For example, the time length may be a time length 602 from a start timing of a first display among the multiple displays to an end timing of a last display among the multiple displays, or a time length 603 from the start timing of the first display of the multiple displays to a start timing (e.g., timing 601) of a first display of a second image subsequent to the first image. For example, the display driver circuitry 120 may receive the second image, based on the timing 601, from the processor 110 through the interface 115, as in a state 604 after the control command 630 is obtained. For example, the display driver circuitry 120 may change the state of the GRAM 125 from the second activation state 220 to the first activation state 210, in response to the time length longer than a reference length, for storing the second image in the GRAM 125 and scanning the second image in the GRAM 125, as indicated by arrow 605. For example, the display driver circuitry 120 may change the state of the GRAM 125 to the first activation state 210, unlike information indicated by the control command 630. For example, the change to the first activation state 210 may be executed to reduce afterimages caused by the first image maintained on the display panel 140 for the time length longer than the reference length.

For example, the display driver circuitry 120 may execute a first displaying of the second image received from the processor 110 as indicated by arrow 606, and store the second image received from the processor 110 in the GRAM 125 having the first activation state 210 as indicated by arrow 607. For example, the display driver circuitry 120 may execute a second displaying of the second image by scanning the second image in the GRAM 125 having the first activation state 210, as indicated by arrow 608. For example, the second displaying of the second image may be executed to reduce the afterimage caused by the first image maintained on the display panel 140 for the time length longer than the reference length. For example, the display driver circuitry 120 may change, in response to the scanning of the second image, the state of the GRAM 125 from the second activation state 220 to the deactivation state 250, based on the control command 630, as indicated by arrow 611.

For example, the display driver circuitry 120 may receive a third image from the processor 110 through the interface 115, as in the state 610, based on a timing 609 of a vertical synchronization signal 391 (or timing 609 of a light-emitting synchronization signal 392) (or timing 609 of a vertical synchronization signal 393). For example, the display driver circuitry 120 may display the third image on the display panel 140, while the GRAM 125 has the deactivation state 250 in accordance with the control command 630, as indicated by arrow 612.

For example, the display driver circuitry 120 may execute another operation distinct from those illustrated through FIG. 6 in accordance with the control command 630, in response to the time length shorter than or equal to the reference length. The other operation may be illustrated through FIG. 7.

FIG. 7 illustrates an exemplary method of changing a state of GRAM from a second activation state to a deactivation state after a control command indicating to cease activating GRAM is obtained.

Referring to FIG. 7, in response to the time length (e.g., a time length 712 or a time length 713) shorter than or equal to the reference length, the display driver circuitry 120 may change the state of the GRAM 125 from the second activation state 220 to the deactivation state 250, as indicated by arrow 701, for bypassing storing the second image in the GRAM 125 in accordance with the control command 630. For example, a time length 712 may be a time length from a start timing of a first display among the multiple displays of the first image to an end timing of a last display among the multiple displays, and a time length 713 may be a time length from the start timing of the first display among the multiple displays of the first image to a start timing of a first display of a second image subsequent to the first image.

For example, the display driver circuitry 120 may change the state of the GRAM 125 to the deactivation state 250 to correspond to information indicated by the control command 630.

For example, the display driver circuitry 120 may bypass storing the second image in the GRAM 125 as indicated by arrow 702 and display the second image on the display panel 140 as indicated by arrow 703.

As described above, the electronic device 100 may reduce power consumed for displaying on the display panel 140, by changing the state of the GRAM 125 including the first activation state 210, the second activation state 220, and the deactivation state 250.

FIG. 8 is a block diagram illustrating an electronic device 801 in a network environment 800 according to various embodiments. Referring to FIG. 8, the electronic device 801 in the network environment 800 may communicate with an electronic device 802 via a first network 898 (e.g., a short-range wireless communication network), or at least one of an electronic device 804 or a server 808 via a second network 899 (e.g., a long-range wireless communication network). According to an embodiment, the electronic device 801 may communicate with the electronic device 804 via the server 808. According to an embodiment, the electronic device 801 may include a processor 820, memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module (SIM) 896, or an antenna module 897. In some embodiments, at least one of the components (e.g., the connecting terminal 878) may be omitted from the electronic device 801, or one or more other components may be added in the electronic device 801. In some embodiments, some of the components (e.g., the sensor module 876, the camera module 880, or the antenna module 897) may be implemented as a single component (e.g., the display module 860).

The processor 820 may execute, for example, software (e.g., a program 840) to control at least one other component (e.g., a hardware or software component) of the electronic device 801 coupled with the processor 820, and may perform various data processing or computation. According to an embodiment, as at least part of the data processing or computation, the processor 820 may store a command or data received from another component (e.g., the sensor module 876 or the communication module 890) in volatile memory 832, process the command or the data stored in the volatile memory 832, and store resulting data in non-volatile memory 834. According to an embodiment, the processor 820 may include a main processor 821 (e.g., a central processing unit (CPU) or an application processor (AP)), or an auxiliary processor 823 (e.g., a graphics processing unit (GPU), a neural processing unit (NPU), an image signal processor (ISP), a sensor hub processor, or a communication processor (CP)) that is operable independently from, or in conjunction with, the main processor 821. For example, when the electronic device 801 includes the main processor 821 and the auxiliary processor 823, the auxiliary processor 823 may be adapted to consume less power than the main processor 821, or to be specific to a specified function. The auxiliary processor 823 may be implemented as separate from, or as part of the main processor 821.

The auxiliary processor 823 may control at least some of functions or states related to at least one component (e.g., the display module 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). According to an embodiment, the auxiliary processor 823 (e.g., an image signal processor or a communication processor) may be implemented as part of another component (e.g., the camera module 880 or the communication module 890) functionally related to the auxiliary processor 823. According to an embodiment, the auxiliary processor 823 (e.g., the neural processing unit) may include a hardware structure specified for artificial intelligence model processing. An artificial intelligence model may be generated by machine learning. Such learning may be performed, e.g., by the electronic device 801 where the artificial intelligence is performed or via a separate server (e.g., the server 808). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input module 850 may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 may output sound signals to the outside of the electronic device 801. The sound output module 855 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 860 may visually provide information to the outside (e.g., a user) of the electronic device 801. The display module 860 may include, for example, a display, a hologram device, or a projector and control circuitry to control a corresponding one of the display, hologram device, and projector. According to an embodiment, the display module 860 may include a touch sensor adapted to detect a touch, or a pressure sensor adapted to measure the intensity of force incurred by the touch.

The audio module 870 may convert a sound into an electrical signal and vice versa. According to an embodiment, the audio module 870 may obtain the sound via the input module 850, or output the sound via the sound output module 855 or a headphone of an external electronic device (e.g., an electronic device 802) directly (e.g., wiredly) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. According to an embodiment, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., wiredly) or wirelessly. According to an embodiment, the interface 877 may include, for example, a high definition multimedia interface (HDMI), a universal serial bus (USB) interface, a secure digital (SD) card interface, or an audio interface.

A connecting terminal 878 may include a connector via which the electronic device 801 may be physically connected with, directly or indirectly, the external electronic device (e.g., the electronic device 802). According to an embodiment, the connecting terminal 878 may include, for example, an HDMI connector, a USB connector, a SD card connector, or an audio connector (e.g., a headphone connector).

The haptic module 879 may convert an electrical signal into a mechanical stimulus (e.g., a vibration or a movement) or electrical stimulus which may be recognized by a user via his tactile sensation or kinesthetic sensation. According to an embodiment, the haptic module 879 may include, for example, a motor, a piezoelectric element, or an electric stimulator.

The camera module 880 may capture a still image or moving images. According to an embodiment, the camera module 880 may include one or more lenses, image sensors, image signal processors, or flashes.

The power management module 888 may manage power supplied to the electronic device 801. According to an embodiment, the power management module 888 may be implemented as at least part of, for example, a power management integrated circuit (PMIC).

The battery 889 may supply power to at least one component of the electronic device 801. According to an embodiment, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor (AP)) and supports a direct (e.g., wired) communication or a wireless communication. According to an embodiment, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The wireless communication module 892 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., the mmWave band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 892 may support various requirements specified in the electronic device 801, an external electronic device (e.g., the electronic device 804), or a network system (e.g., the second network 899). According to an embodiment, the wireless communication module 892 may support a peak data rate (e.g., 20 Gbps or more) for implementing eMBB, loss coverage (e.g., 864 dB or less) for implementing mMTC, or U-plane latency (e.g., 0.5 ms or less for each of downlink (DL) and uplink (UL), or a round trip of 8 ms or less) for implementing URLLC.

The antenna module 897 may transmit or receive a signal or power to or from the outside (e.g., the external electronic device) of the electronic device 801. According to an embodiment, the antenna module 897 may include an antenna including a radiating element composed of a conductive material or a conductive pattern formed in or on a substrate (e.g., a printed circuit board (PCB)). According to an embodiment, the antenna module 897 may include a plurality of antennas (e.g., array antennas). In such a case, at least one antenna appropriate for a communication scheme used in the communication network, such as the first network 898 or the second network 899, may be selected, for example, by the communication module 890 (e.g., the wireless communication module 892) from the plurality of antennas. The signal or the power may then be transmitted or received between the communication module 890 and the external electronic device via the selected at least one antenna. According to an embodiment, another component (e.g., a radio frequency integrated circuit (RFIC)) other than the radiating element may be additionally formed as part of the antenna module 897.

According to various embodiments, the antenna module 897 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 801 and the external electronic device 804 via the server 808 coupled with the second network 899. Each of the electronic devices 802 or 804 may be a device of a same type as, or a different type, from the electronic device 801. According to an embodiment, all or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 801. The electronic device 801 may provide the outcome, with or without further processing of the outcome, as at least part of a reply to the request. To that end, a cloud computing, distributed computing, mobile edge computing (MEC), or client-server computing technology may be used, for example. The electronic device 801 may provide ultra low-latency services using, e.g., distributed computing or mobile edge computing. In another embodiment, the external electronic device 804 may include an internet-of-things (IoT) device. The server 808 may be an intelligent server using machine learning and/or a neural network. According to an embodiment, the external electronic device 804 or the server 808 may be included in the second network 899. The electronic device 801 may be applied to intelligent services (e.g., smart home, smart city, smart car, or healthcare) based on 5G communication technology or IoT-related technology.

FIG. 9 is a block diagram 900 illustrating the display module 860 according to various embodiments. Referring to FIG. 9, the display module 860 may include a display 910 and a display driver integrated circuit (DDI) 930 to control the display 910. The DDI 930 may include an interface module 931, memory 933 (e.g., buffer memory), an image processing module 935, or a mapping module 937. The DDI 930 may receive image information that contains image data or an image control signal corresponding to a command to control the image data from another component of the electronic device 801 via the interface module 931. For example, according to an embodiment, the image information may be received from the processor 820 (e.g., the main processor 821 (e.g., an application processor)) or the auxiliary processor 823 (e.g., a graphics processing unit) operated independently from the function of the main processor 821. The DDI 930 may communicate, for example, with touch circuitry 950 or the sensor module 876 via the interface module 931. The DDI 930 may also store at least part of the received image information in the memory 933, for example, on a frame by frame basis. The image processing module 935 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 910. The mapping module 937 may generate a voltage value or a current value corresponding to the image data pre-processed or post-processed by the image processing module 935. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 910 may be driven, for example, based at least in part on the voltage value or the current value such that visual information (e.g., a text, an image, or an icon) corresponding to the image data may be displayed via the display 910.

According to an embodiment, the display module 860 may further include the touch circuitry 950. The touch circuitry 950 may include a touch sensor 951 and a touch sensor IC 953 to control the touch sensor 951. The touch sensor IC 953 may control the touch sensor 951 to sense a touch input or a hovering input with respect to a certain position on the display 910. To achieve this, for example, the touch sensor 951 may detect (e.g., measure) a change in a signal (e.g., a voltage, a quantity of light, a resistance, or a quantity of one or more electric charges) corresponding to the certain position on the display 910. The touch circuitry 950 may provide input information (e.g., a position, an area, a pressure, or a time) indicative of the touch input or the hovering input detected via the touch sensor 951 to the processor 820. According to an embodiment, at least part (e.g., the touch sensor IC 953) of the touch circuitry 950 may be formed as part of the display 910 or the DDI 930, or as part of another component (e.g., the auxiliary processor 823) disposed outside the display module 860.

According to an embodiment, the display module 860 may further include at least one sensor (e.g., a fingerprint sensor, an iris sensor, a pressure sensor, or an illuminance sensor) of the sensor module 876 or a control circuit for the at least one sensor. In such a case, the at least one sensor or the control circuit for the at least one sensor may be embedded in one portion of a component (e.g., the display 910, the DDI 930, or the touch circuitry 950)) of the display module 860. For example, when the sensor module 876 embedded in the display module 860 includes a biometric sensor (e.g., a fingerprint sensor), the biometric sensor may obtain biometric information (e.g., a fingerprint image) corresponding to a touch input received via a portion of the display 910. As another example, when the sensor module 876 embedded in the display module 860 includes a pressure sensor, the pressure sensor may obtain pressure information corresponding to a touch input received via a partial or whole area of the display 910. According to an embodiment, the touch sensor 951 or the sensor module 876 may be disposed between pixels in a pixel layer of the display 910, or over or under the pixel layer.

As described above, according to an embodiment, an electronic device 100 may comprise display driver circuitry 120 including a graphic random access memory (GRAM) 125, and a display panel 140. According to an embodiment, the display driver circuitry 120 may be configured to, based on scanning an image in the GRAM 125 having a first activation state obtaining power in a first range, display the image on the display panel 140. According to an embodiment, the display driver circuitry 120 may be configured to, in response to the scanning, change a state of the GRAM 125 from the first activation state to a second activation state obtaining power in a second range for maintaining the image in the GRAM 125, the power in the second range lower than the power in the first range. A refresh rate for the image in the GRAM may be lower than a reference refresh rate.

According to an embodiment, the electronic device 100 may further comprise a processor 110. According to an embodiment, the display driver circuitry 120 may be configured to change the state of the GRAM 125 from the second activation state to the first activation state, for receiving another image from the processor 110 or scanning again the image.

According to an embodiment, the display driver circuitry 120 may be configured to, based on receiving the other image from the processor 110, execute first displaying of the other image on the display panel 140 and store the other image in the GRAM 125 having the first activation state changed from the second state. According to an embodiment, the display driver circuitry 120 may be configured to execute second displaying of the other image on the display panel 140 by scanning the other image in the GRAM 125 having the first activation state.

According to an embodiment, the display driver circuitry 120 may be configured to display the image on the display panel 140 by scanning again the image in the GRAM 125 having the first activation state changed from the second activation state.

According to an embodiment, the display driver circuitry 120 may be configured to obtain, from the processor 110, a control command indicating to activate the GRAM 125 for displaying on the display panel 140. According to an embodiment, the display driver circuitry 120 may be configured to, in response to the control command, change the state of the GRAM 125 from a deactivation state to the first activation state. According to an embodiment, the display driver circuitry 120 may be configured to, based on receiving, from the processor 110, the image after the state of the GRAM 125 is changed from the deactivation state to the first activation state, execute first displaying of the image on the display panel 140 and store the image in the GRAM 125 having the first activation state changed from the deactivation state. According to an embodiment, the display driver circuitry 120 may be configured to display the image on the display panel 140 by executing second displaying of the image in accordance with scanning the image in the GRAM 125 having the first activation state.

According to an embodiment, the display driver circuitry 120 may be configured to obtain, from the processor 110, the control command in a first time interval being before a second time interval. According to an embodiment, the display driver circuitry 120 may be configured to, in a portion of the second time interval, execute the reception of the image from the processor 110, the first displaying of the image, the storing of the image, and the second displaying of the image in accordance with the scanning of the image. According to an embodiment, the display driver circuitry 120 may be configured to, in another portion of the second time interval, change the state of the GRAM 125 from the first activation state to the second activation state. According to an embodiment, the state of the GRAM 125 may be changed to the first activation state before a third time interval being after the second time interval.

According to an embodiment, a start timing of each of the first time interval, the second time interval, and the third time interval may correspond to a timing capable of executing an image transmission from the processor 110 to the display driver circuitry 120.

According to an embodiment, the display driver circuitry 120 may be configured to, based on a width of a pulse signal periodically transmitted from the processor 110 to the display driver circuitry 120, obtain the control command.

According to an embodiment, providing power to the GRAM 125 may be ceased in the deactivation state.

According to an embodiment, the processor 110 may be configured to, based on the refresh rate for the image lower than the reference refresh rate, provide the control command to the display driver circuitry 120.

According to an embodiment, the display driver circuitry 120 may be configured to receive, from the processor 110, another image subsequent to the image. According to an embodiment, the display driver circuitry 120 may be configured to, based on the other image or a timing capable of receiving the other image, bypass storing in the GRAM 125 the other image by changing the state of the GRAM 125 to the deactivation state in accordance with the control command and display on the display panel 140 the other image.

According to an embodiment, the display driver circuitry 120 may be configured to, based on the control command, change the state of the GRAM 125 from the second activation state to the first activation state before a timing capable of starting an image transmission from the processor 110 to the display driver circuitry 120. According to an embodiment, the display driver circuitry 120 may be configured to store another image, subsequent to the image, received from the processor 110 based on the timing, in the GRAM 125 having the first activation state, and display, on the display panel 140, the other image. According to an embodiment, the display driver circuitry 120 may be configured to display again, on the display panel 140, the other image in accordance with scanning the other image in the GRAM 125 having the first activation state.

According to an embodiment, the display driver circuitry 120 may be configured to change the state of the GRAM 125 from the deactivation state to the first activation state to have a reference time interval between a first time interval in which the GRAM 125 has the deactivation state and a second time interval in which the GRAM 125 has the first activation state.

According to an embodiment, the reference time interval may be scheduled between the first time interval and the second time interval, for providing, to the GRAM 125, the power in the first range.

According to an embodiment, the display driver circuitry 120 may be configured to change the state from the first activation state to the second activation state to have a reference time interval between a first time interval in which the GRAM 125 has the first activation state and a second time interval in which the GRAM 125 has the second activation state. According to an embodiment, the display driver circuitry 120 may be configured to change the state from the second activation state to the first activation active state to have the reference time interval between the second time interval and the first time interval.

According to an embodiment, the reference time interval may be scheduled between the first time interval and the second time interval to change the power in the first range to the power in the second range or change the power in the second range to the power in the first range.

According to an embodiment, the display driver circuitry 120 may be configured to obtain, from the processor 110, a control command indicating to cease activating the GRAM 125 after the image is displayed on the display panel 140. According to an embodiment, the display driver circuitry 120 may be configured to identify a time length in which displaying of the image on the display panel 140 is maintained based on the control command. According to an embodiment, the display driver circuitry 120 may be configured to, in response to the time length longer than a reference length, store in the GRAM 125 another image received from the processor 110 after the control command is obtained and change the state from the second activation state to the first activation state for scanning the other image stored in the GRAM 125. According to an embodiment, the display driver circuitry 120 may be configured to, in response to the time length shorter than or equal to the reference length, change the state from the second activation state to the deactivation state to bypass storing the other image in the GRAM 125 in accordance with the control command.

According to an embodiment, the first activation state may be provided based on a first voltage provided to the GRAM 125. According to an embodiment, the second activation state may be provided based on a second voltage provided to the GRAM 125. According to an embodiment, the second voltage may be lower than the first voltage.

As described above, a method may be executed in an electronic device 100 including display driver circuitry 120 and a display panel 140. According to an embodiment, the method may comprise, based on scanning an image in the GRAM 125 having a first activation state obtaining power in a first range, displaying, by the display driver circuitry 120, the image on the display panel 140. According to an embodiment, the method may comprise, in response to the scanning, changing, by the display driver circuitry 120, a state of the GRAM 125 from the first activation state to a second activation state obtaining power in a second range for maintaining the image in the GRAM 125, the power in the second range lower than the power in the first range. A refresh rate for the image in the GRAM may be lower than a reference refresh rate.

According to an embodiment, the method may comprise changing, by the display driver circuitry 120, the state of the GRAM 125 from the second activation state to the first activation state, for receiving another image from a processor 110 of the electronic device 100 or scanning again the image.

According to an embodiment, the method may comprise, based on receiving the other image from the processor 110, executing, by the display driver circuitry 120, first displaying of the other image on the display panel 140 and storing, by the display driver circuitry 120, the other image in the GRAM 125 having the first activation state changed from the second state. According to an embodiment, the method may comprise, executing, by the display driver circuitry 120, second displaying of the other image on the display panel 140 by scanning the other image in the GRAM 125 having the first activation state.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” or “connected to” another element (e.g., a second element), it means that the element may be coupled with the other element directly (e.g., wiredly), wirelessly, or via at least a third element(s). Thus, for example, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Various embodiments as set forth herein may be implemented as software (e.g., the program 840) including one or more instructions that are stored in a storage medium (e.g., internal memory 836 or external memory 838) that is readable by a machine (e.g., the electronic device 801). For example, a processor (e.g., the processor 820) of the machine (e.g., the electronic device 801) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
display driver circuitry including a graphic random access memory (GRAM); and
a display panel,
wherein the display driver circuitry is configured to:
based on scanning an image in the GRAM having a first activation state obtaining power in a first range, display the image on the display panel; and
in response to the scanning, change a state of the GRAM from the first activation state to a second activation state obtaining power in a second range for maintaining the image in the GRAM, wherein the power in the second range is lower than the power in the first range, and
wherein a refresh rate for the image in the GRAM is lower than a reference refresh rate.

2. The electronic device of claim 1, further comprising:
a processor comprising processing circuitry,
wherein the display driver circuitry is further configured to:
change the state of the GRAM from the second activation state to the first activation state, for receiving another image from the processor or scanning again the image.

3. The electronic device of claim 2, wherein the display driver circuitry is further configured to:
based on receiving the another image from the processor, execute first displaying of the another image on the display panel and store the another image in the GRAM having the first activation state changed from the second activation state; and
execute second displaying of the another image on the display panel at least by scanning the another image in the GRAM having the first activation state.

4. The electronic device of claim 2, wherein the display driver circuitry is configured to:
display the image on the display panel at least by scanning again the image in the GRAM having the first activation state changed from the second activation state.

5. The electronic device of claim 2, wherein the display driver circuitry is configured to:
obtain, from the processor, a control command indicating to activate the GRAM for displaying on the display panel;
in response to the control command, change the state of the GRAM from a deactivation state to the first activation state;
based on receiving, from the processor, the image after the state of the GRAM is changed from the deactivation state to the first activation state, execute first displaying of the image on the display panel and store the image in the GRAM having the first activation state changed from the deactivation state; and
display the image on the display panel at least by executing second displaying of the image in accordance with scanning the image in the GRAM having the first activation state.

6. The electronic device of claim 5, wherein the display driver circuitry is configured to:
obtain, from the processor, the control command in a first time interval being before a second time interval;
in a portion of the second time interval, execute the reception of the image from the processor, the first displaying of the image, the storing of the image, and the second displaying of the image in accordance with the scanning of the image; and
in another portion of the second time interval, change the state of the GRAM from the first activation state to the second activation state, and
wherein the state of the GRAM is to be changed to the first activation state before a third time interval being after the second time interval.

7. The electronic device of claim 6, wherein a start timing of each of the first time interval, the second time interval, and the third time interval corresponds to a timing for executing an image transmission from the processor to the display driver circuitry.

8. The electronic device of claim 5, wherein the display driver circuitry is configured to:
based on a width of a pulse signal periodically transmitted from the processor to the display driver circuitry, obtain the control command.

9. The electronic device of claim 5, wherein providing power to the GRAM is ceased in the deactivation state.

10. The electronic device of claim 5, wherein the processor is configured to:
based on the refresh rate for the image being lower than the reference refresh rate, provide the control command to the display driver circuitry.

11. The electronic device of claim 5, wherein the display driver circuitry is further configured to:
receive, from the processor, another image subsequent to the image; and
based on the another image and/or a timing capable of receiving the another image, bypass storing in the GRAM the another image at least by changing the state of the GRAM to the deactivation state in accordance with the control command and display on the display panel the another image.

12. The electronic device of claim 5, wherein the display driver circuitry is further configured to:
based on the control command, change the state of the GRAM from the second activation state to the first activation state before a timing capable of starting an image transmission from the processor to the display driver circuitry;
store another image, subsequent to the image, received from the processor based on the timing, in the GRAM having the first activation state, and display, on the display panel, the another image; and
display again, on the display panel, the another image in accordance with scanning the other image in the GRAM having the first activation state.

13. The electronic device of claim 5, wherein the display driver circuitry is configured to:
change the state of the GRAM from the deactivation state to the first activation state to have a reference time interval between a first time interval in which the GRAM has the deactivation state and a second time interval in which the GRAM has the first activation state.

14. The electronic device of claim 13, wherein the reference time interval is scheduled between the first time interval and the second time interval, for providing, to the GRAM, the power in the first range.

15. The electronic device of claim 2, wherein the display driver circuitry is configured to:
change the state of the GRAM from the first activation state to the second activation state so as to have a reference time interval between at least a first time interval in which the GRAM has the first activation state and a second time interval in which the GRAM has the second activation state; and
change the state of the GRAM from the second activation state to the first activation state to have the reference time interval between at least the second time interval and the first time interval.

16. The electronic device of claim 15, wherein the reference time interval is scheduled between the first time interval and the second time interval to change the power in the first range to the power in the second range or change the power in the second range to the power in the first range.

17. The electronic device of claim 2, wherein the display driver circuitry is further configured to:
after the image is displayed on the display panel, obtain, from the processor, a control command indicating to cease activating the GRAM;
based on the control command, identify a time length in which displaying of the image on the display panel is maintained;
in response to the time length being longer than a reference length, change the state of the GRAM from the second activation state to the first activation state to store another image received from the processor after the control command is obtained and scan the another image stored in the GRAM; and
in response to the time length being shorter than the reference length, change the state of the GRAM from the second activation state to the deactivation state to bypass storing the other image in the GRAM in accordance with the control command.

18. The electronic device of claim 1, wherein the first activation state is provided based on a first voltage provided to the GRAM,
wherein the second activation state is provided based on a second voltage provided to the GRAM, and
wherein the second voltage is lower than the first voltage.

19. A method executed in an electronic device including display driver circuitry comprising a graphic random access memory (GRAM), and a display panel, the method comprising:
based on scanning an image in the GRAM having a first activation state obtaining power in a first range, displaying, by the display driver circuitry, the image on the display panel; and
in response to the scanning, changing, by the display driver circuitry, a state of the GRAM from the first activation state to a second activation state obtaining power in a second range for maintaining the image in the GRAM, the power in the second range being lower than the power in the first range, and
wherein a refresh rate for the image in the GRAM is lower than a reference refresh rate.

20. The method of claim 19, further comprising:
changing, by the display driver circuitry, the state of the GRAM from the second activation state to the first activation state, for receiving another image from the processor or scanning again the image.
